(19) United States
(12) Patent Application Publication
(10) Pub. No.: US 2008/0107395 A1
(43) Pub. Date: May 8, 2008

(54) Broadcast reception apparatus and digital broadcast receiver

(75) Inventor: Takahisa Honda, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd., Osaka (JP)

(21) Appl. No.: 11/976,706

(22) Filed: Oct. 26, 2007

(30) Foreign Application Priority Data
Nov. 7, 2006 (JP) 2006-301250

(51) Int. Cl. H04N 5/91

(52) U.S. Cl. 386/83

(57) ABSTRACT

An MPU 11 in a digital broadcast receiver includes a program reservation portion 111 which accepts manipulations from a user, through a remotecontroller 2, and which sets start date and hour information and end date and hour information of a program on the basis of the accepted manipulations; a date and hour decision portion 112 which decides whether or not the start date and hour set by the program reservation portion 111 have been reached; a display propriety decision portion 113 which decides whether or not the broadcast reception apparatus is in a displayable state being a state where an output is given to a display in a manner to be visible from outside, when it has been decided by the date and hour decision portion 112 that the start date and hour have been reached; and a reserved recording portion 114 which causes the broadcast reception apparatus to receive the program set by the program reservation portion 111 and which causes a DVD recorder 3 to record the received program, when it has been decided by the display propriety decision portion 113 that the broadcast reception apparatus is not in the displayable state.

### BACKGROUND OF THE INVENTION

The present application is based on Japanese Patent Application No. 2006-301250 filed on Nov. 7, 2006.

### FIELD OF THE INVENTION

The present invention relates to a broadcast reception apparatus and a digital broadcast receiver which receive a television broadcast and output the television broadcast to a monitor in a manner to be visible from outside, and which are communicably connected with an information record apparatus that stores received information therein. More particularly, it relates to a digital broadcast receiver which is communicably connected with an information record apparatus through an HDMI (High Definition Multimedia Interface).

### DESCRIPTION OF THE RELATED ART

Although the number of channels has been on the order of several—several tens in conventional analog broadcasting, it amounts even to several hundred in digital broadcasting which is coming into wide use in recent years. In addition, as multichannelization proceeds in this manner, an enormous number of programs have come to be provided. In the digital broadcasting, therefore, the information of, for example, a program table is transmitted as an electronic program table, and the information of the electronic program table received by a broadcast receiver is reproduced and is displayable on a monitor.

A viewer or the like is permitted to make a viewing reservation by clicking the program frame of the program table displayed on the monitor. Besides, various broadcast reception apparatuses have been proposed in order to facilitate the viewing reservation still further. By way of example, JP-A-2000-295538 discloses a broadcast reception apparatus wherein information items containing any desired character string are retrieved from the character string information of program content information, the retrieved information items are created as a listing, and the listing is displayed on a monitor. According to this broadcast reception apparatus, the viewer or the like can make the viewing reservation by easily selecting a program which he/she desires to view.

However, even when the viewing reservation is made, the viewer or the like might miss the reserved program in a case where the broadcast reception apparatus is in a standby state or the like state in which the reserved program is not outputted to the monitor. In a case, for example, where the viewer or the like has come to go out for any reason, where he/she forgets that the viewing reservation has been made, and where he/she brings the broadcast reception apparatus into the standby state, he/she will miss the reserved program even when the broadcast reception apparatus is to output the reserved program to the monitor on the basis of the viewing reservation.

### SUMMARY OF THE INVENTION

The present invention has been made in view of the above problem, and it has for its object to provide a broadcast reception apparatus and a digital broadcast receiver by which a program reserved to be viewed can be reliably viewed.

In order to accomplish the object, the invention consists in a broadcast reception apparatus which receives a television broadcast and outputs the received television broadcast to a monitor in a manner to be visible from outside, and which is communicably connected with an information record apparatus that stores received information therein; including program reservation means for accepting external manipulations, and for setting start date and hour information and end date and hour information of a program on the basis of the accepted manipulations; date and hour decision means for deciding whether or not the start date and hour set by the program reservation means have been reached; display propriety decision means for deciding whether or not the broadcast reception apparatus is in a displayable state being a state where an output is given to a monitor in a manner to be visible from outside, when it has been decided by the date and hour decision means that the start date and hour have been reached; and reserved recording means for causing the broadcast reception apparatus to receive the program set by the program reservation means, and for causing the information record apparatus to record the received program, when it has been decided by the display propriety decision means that the broadcast reception apparatus is not in the displayable state.

According to this configuration, the external manipulations are accepted, the start date and hour information and end date and hour information of the program are set on the basis of the accepted manipulations, and whether or not the set start date and hour have been reached is decided. In addition, subject to the decision that the start date and hour have been reached, it is decided whether or not the broadcast reception apparatus is in the displayable state being the state where the output is given to the monitor in the manner to be visible from outside, and subject to the decision that the broadcast reception apparatus is not in the displayable state, the set program (namely, the program reserved to be viewed) is received, and the received program is recorded by the information record apparatus. Therefore, the program reserved to be viewed can be viewed without fail.

That is, subject to the decision that the broadcast reception apparatus is not in the displayable state, the program reserved to be viewed is recorded by the information record apparatus. It is therefore permitted to read out the program recorded by the information record apparatus, and to output the recorded program to the monitor in the visible manner. Accordingly, the program reserved to be viewed can be viewed without fail.

Besides, the invention consists in the broadcast reception apparatus of the above configuration, wherein the broadcast reception apparatus is connected to the information record apparatus in a manner to be capable of communicating instruction information which brings the information record apparatus into a recordable state.

According to this configuration, the broadcast reception apparatus is connected to the information record apparatus in the manner to be capable of communicating the instruction information which brings the information record apparatus into the recordable state. Therefore, even when the information record apparatus is in a state where its power source is OFF (or in its standby state), it can be shifted into the recordable state (or into the state where its power source is ON), and it can be caused to record the program reserved to be viewed, without fail.

Besides, the invention consists in the broadcast reception apparatus of the above configuration, wherein the broadcast reception apparatus is connected with the information record apparatus communicably through an HDMI (High Definition Multimedia Interface); and the reserved recording means causes the information record apparatus to record the program set by the program reservation means, through the HDMI.

According to this configuration, the set program (namely, the program reserved to be viewed) is recorded by the information record apparatus through the HDMI. Therefore, even when the information record apparatus is in a state where its power source is OFF (or in its standby state), it can be shifted into the recordable state (or into the state where its power source is ON) through the HDMI, and it can be caused to record the program reserved to be viewed, without fail.

Besides, the invention consists in the broadcast reception apparatus of the above configuration, wherein the broadcast reception apparatus is connected with the information record apparatus communicably through infrared communications; and the reserved recording means causes the information record apparatus to record the program set by the program reservation means, through the infrared communications.

According to this configuration, the set program (namely, the program reserved to be viewed) is recorded by the information record apparatus through the infrared communications. Therefore, even when the information record apparatus is in a state where its power source is OFF (or in its standby state), it can be shifted into the recordable state (or into the state where its power source is ON) through the infrared communications, and it can be caused to record the program reserved to be viewed, without fail.

Besides, the invention consists in the broadcast reception apparatus of the above configuration, wherein the broadcast reception apparatus is configured unitarily with the information record apparatus.

According to this configuration, the broadcast reception apparatus is configured unitarily with the information record apparatus. Therefore, even when the information record apparatus is in a state where its power source is OFF (or in its standby state), it can be shifted into the recordable state (or into the state where its power source is ON), and it can be caused to record the program reserved to be viewed, without fail.

That is, since the broadcast reception apparatus is configured unitarily with the information record apparatus, instruction information can be easily outputted from the broadcast reception apparatus to the information record apparatus. Therefore, the information record apparatus can be caused to record the program reserved to be viewed, without fail.

Besides, the invention consists in the broadcast reception apparatus of the above configuration, including switch means for causing the broadcast reception apparatus to receive the program set by the program reservation means and to output the received program to the monitor, when it has been decided by the display propriety decision means that the broadcast reception apparatus is in the displayable state.

According to this configuration, subject to the decision that the broadcast reception apparatus is in the displayable state, the set program (namely, the program reserved to be viewed) is received, and the received program is outputted to the monitor. Therefore, the program reserved to be viewed can be easily viewed.

### DESCRIPTION OF THE DRAWINGS

FIG. 1 is an architectural diagram showing an example of the connection state of a digital broadcast receiver according to the present invention;

FIG. 2 is a block diagram showing an example of the configuration of the digital broadcast receiver;

FIG. 3 is a block diagram showing an example of the configuration of a DVD recorder;

FIG. 4 is a block diagram showing an example of the configuration of principal portions in the digital broadcast receiver according to the invention; and

FIG. 5 is a flow chart showing an example of the operation of the digital broadcast receiver (chiefly, an MPU).

### DESCRIPTION OF THE PREFERRED EMBODIMENTS

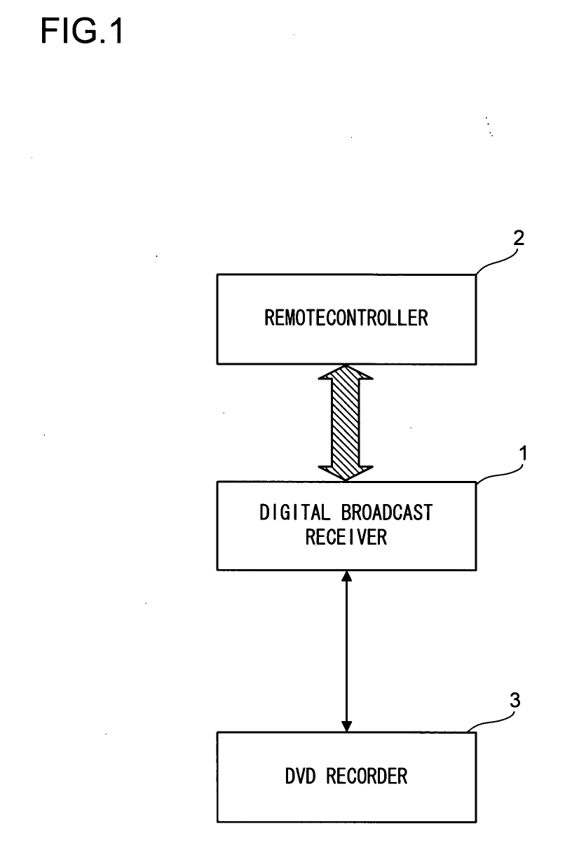

Now, embodiments of the present invention will be described with reference to the drawings. FIG. 1 is an architectural diagram showing an example of the connection state of a digital broadcast receiver according to the invention. The digital broadcast receiver 1 (corresponding to a broadcast reception apparatus) is communicably connected with a remotecontroller 2 through infrared communications, and it is communicably connected with a DVD (Digital Versatile Disk) recorder 3 (corresponding to an information record apparatus) through an HDMI (High Definition Multimedia Interface) cable (namely, by employing an HDMI standard).

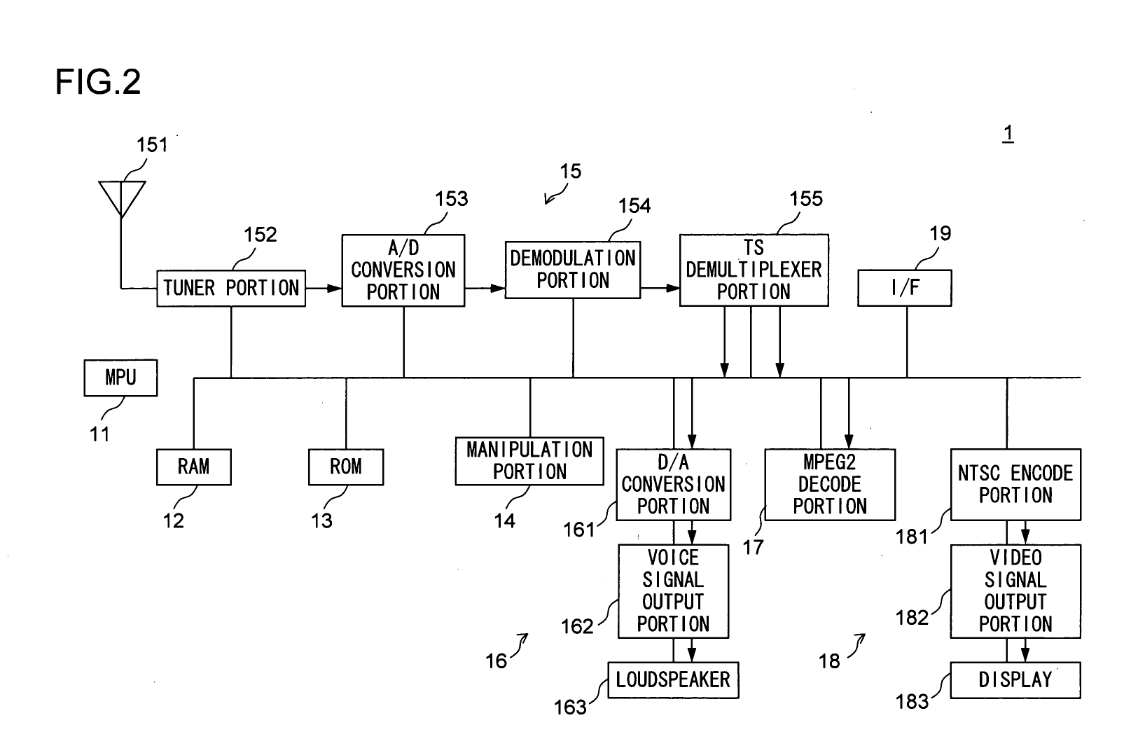

The digital broadcast receiver 1 accepts a manipulating input from a user, through the remotecontroller 2 and receives a television broadcast, so as to output images to a display 183 to be explained later with reference to FIG. 2 and to output voices through a loudspeaker 163 to be explained later with reference to FIG. 2. Besides, the digital broadcast receiver 1 outputs various instruction information items, the received dynamic image information items, etc. to the DVD recorder 3 through the HDMI cable.

The remotecontroller 2 (corresponding to part of program reservation means) accepts the manipulating input from the user, and it generates an infrared signal corresponding to the manipulating input and outputs the generated signal to the digital broadcast receiver 1.

The DVD recorder 3 accepts the instruction information items from the digital broadcast receiver 1, through the HDMI cable, and it records the dynamic image information items, etc. from the digital broadcast receiver 1, onto a DVD.

FIG. 2 is a block diagram showing an example of the configuration of the digital broadcast receiver 1. The digital broadcast receiver 1 includes an MPU 11, a RAM 12, a ROM 13, a manipulation portion 14, a reception portion 15, a voice output portion 16, an MPEG2 decode portion 17, an image output portion 18, and an HDMI interface portion 19.

The MPU (Micro Processing Unit) 11 controls the operation of the whole digital broadcast receiver 1. The RAM (Random Access Memory) 12 stores therein the information items of voice information, dynamic image information, etc. in readable/writable fashion. The ROM (Read Only Memory) 13 stores therein a control program for operating the MPU 11, etc.

The manipulation portion 14 accepts various manipulations such as the ON and OFF manipulations of a power source, and a channel selection. Besides, the manipulation portion 14 accepts various manipulations by receiving manipulation signals from the remotecontroller 2, through the infrared communications. The reception portion 15 receives and demodulates the television broadcast, and it includes an antenna portion 151, a tuner portion 152, an A/D conversion portion 153, a demodulation portion 154, and a TS demultiplexer 155.

The antenna portion 151 receives television broadcast waves. The tuner portion 152 selects the broadcast of a preset channel from within the television broadcast waves received by the antenna portion 151. The A/D conversion portion 153 converts an output signal (analog signal) from the tuner portion 152, into digital information. The demodulation portion 154 demodulates the output information from the A/D conversion portion 153. The TS (Transport Stream) demultiplexer 155 demultiplexes the output information demodulated by the demodulation portion 154, and outputs the demultiplexed information items for respective sorts.

The voice output portion 16 outputs the voices corresponding to the television broadcast received by the reception portion 15 (or the information stored in the DVD recorder 3), and it includes a D/A conversion portion 161, a voice signal output portion 162, and the loudspeaker 163. The D/A conversion portion 161 converts the voice information (digital information) outputted from the TS demultiplexer 155, into an analog signal. The voice signal output portion 162 outputs a voice signal which has been converted into the analog signal by the D/A conversion portion 161. The loudspeaker 163 outputs the voice which corresponds to the voice signal outputted from the voice signal output portion 162.

The “MPEG (Motion Picture Experts Group)2” decode portion 17 decodes dynamic image information outputted from the TS demultiplexer 155, into the dynamic image information before being compressed.

The image output portion 18 outputs the dynamic image information decoded by the MPEG2 decode portion 17, and it includes an NTSC encode portion 181, a video signal output portion 182, and the display 183. The NTSC (National Television Standards Committee) encode portion 181 converts the dynamic image information decoded by the MPEG2 decode portion 17, into a television signal of NTSC format. The video signal output portion 182 outputs the NTSC-format television signal outputted from the NTSC encode portion 181, to the display 183. The display 183 (corresponding to the monitor) is configured of an LCD (Liquid Crystal Display), a PDP (Plasma Display Panel) or the like, and it displays a dynamic image corresponding to the television signal outputted from the video signal output portion 182.

The HDMI interface portion 19 transmits and receives the various information items such as instruction information, dynamic image information and voice information, to and from the DVD recorder 3 through the HDMI cable.

Next, there will be described an operation in the case where the digital broadcast receiver 1 receives a broadcast. First, digital broadcast waves transmitted in are received by the antenna portion 151. In a case where a channel selection manipulation has been accepted through the manipulation portion 14, a transponder which is received by the tuner portion 152 is switched. The received digital broadcast wave is converted into digital information by the A/D conversion portion 153, and the digital information is demodulated by the demodulation portion 154.

Incidentally, the digital broadcast wave is transmitted as TS (Transport Stream) packets from a transmission side (transmission station). The TS packets are formed of control information items which contain the dynamic image information, the voice information, channel information, etc., and the control information items are demultiplexed and outputted by the TS demultiplexer 155 so as to be stored in the RAM 12. In addition, the voice information read out from the RAM 12 is converted into the analog signal by the D/A conversion portion 161, and the voice is outputted from the loudspeaker 163 through the voice signal output portion 162.

Besides, the dynamic image information read out from the RAM 12 is decoded into the dynamic image information before being compressed, by the MPEG2 decode portion 17, and the dynamic image information is converted into the television signal of the NTSC format by the NTSC encode portion 181, until the dynamic image is displayed on the display 183 through the video signal output portion 182.

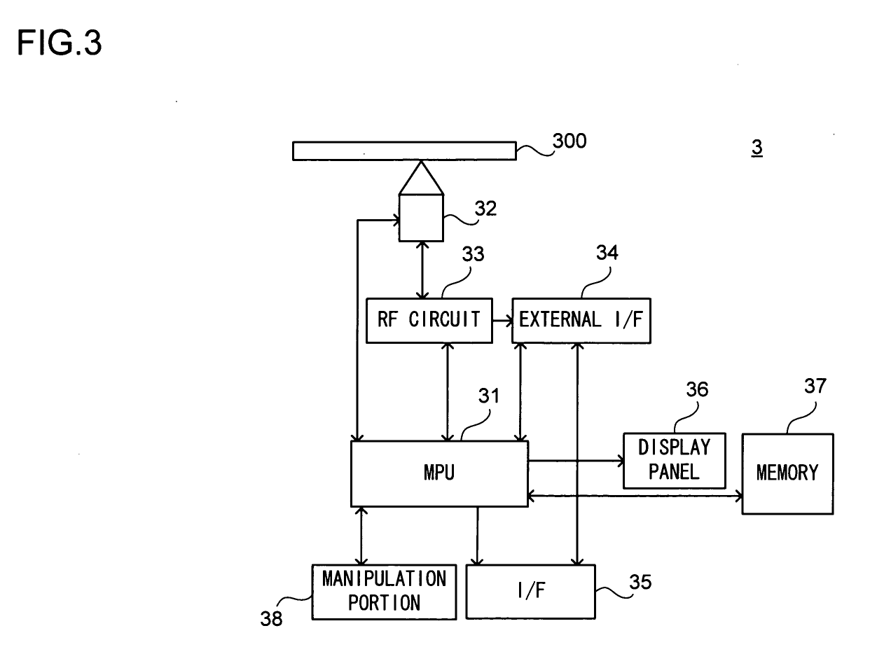

FIG. 3 is a block diagram showing an example of the configuration of the DVD recorder 3. The DVD recorder 3 includes an MPU 31, an optical pickup 32, an RF circuit 33, an external interface portion 34, an HDMI interface portion 35, a display portion 36, a memory 37, and a manipulation portion 38.

The MPU 31 controls the operation of the whole DVD recorder 3. Here, the MPU 31 accepts instruction information from the digital broadcast receiver 1 through the HDMI interface portion 35 so as to perform various operations, and it accepts dynamic image information and the like program information from the digital broadcast receiver 1 through the HDMt interface portion 35 so as to store the accepted information items in a DVD-RAM 300.

The optical pickup 32 projects a laser beam onto the DVD-RAM 300 so as to write (and read) data. The RF circuit 33 processes an RF (Radio Frequency) signal which is outputted to the optical pickup 32 (or which is outputted from the optical pickup 32). The external interface portion 34 performs the conversions of data formats, etc. in the cases of inputting and outputting data between the DVD recorder 3 and external input/output equipments. The HDMI interface portion 35 transmits and receives various information items, such as instruction information, dynamic image information and voice information, to and from the digital broadcast receiver 1 through the HDMI cable in conformity with the HDMI standard.

The display portion 36 is configured of, for example, an LCD (Liquid Crystal Display), and it displays various information items, such as guidance information, message information and setting information, in a manner to be visible from outside. The memory 37 stores various setting information items, etc. therein. The manipulation portion 38 includes various manipulation buttons, and it accepts external manipulation inputs through the manipulation buttons.

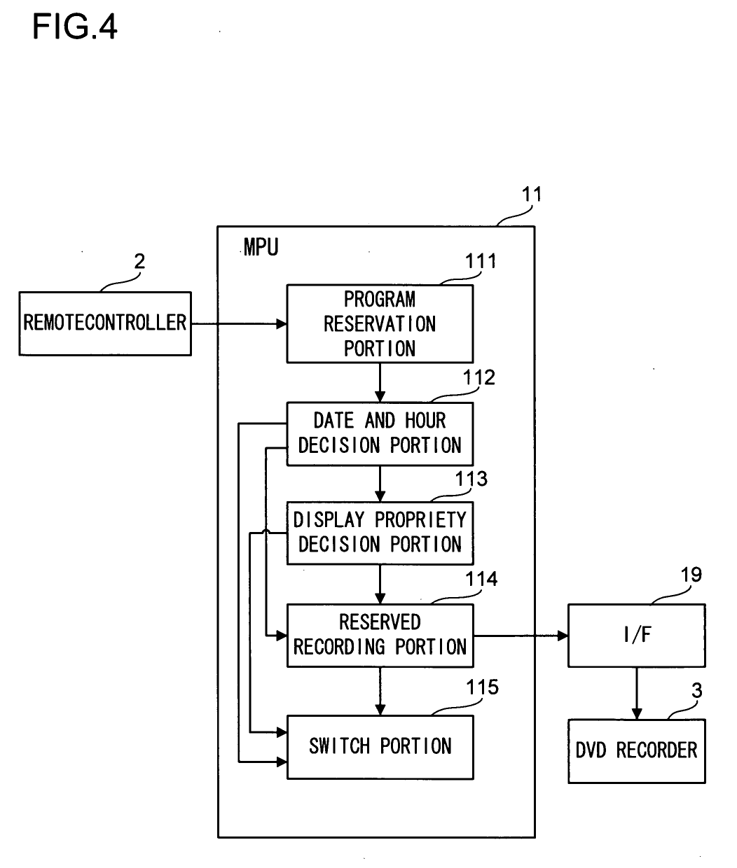

FIG. 4 is a block diagram showing an example of the configuration of principal portions in the digital broadcast receiver 1 according to the invention. The MPU 11 shown in FIG. 2, functionally includes a program reservation portion 111, a date and hour decision portion 112, a display propriety decision portion 113, a reserved recording portion 114, and a switch portion 115.

Here, the MPU 11 reads out and runs the control program previously stored in the ROM 13 shown in FIG. 2, or the like, thereby to function as the functional portions of the program reservation portion 111, date and hour decision portion 112, display propriety decision portion 113, reserved recording portion 114 and switch portion 115.

Besides, among the various sorts of data which are stored in the RAM 12 and ROM 13 shown in FIG. 2, data which can be stored in a detachable record medium may well be made readable by a driver, for example, a hard disk drive, an optical disk drive, a flexible disk drive, a silicon disk drive, or a cassette medium reader. In this case, the record medium is, for example, a hard disk, an optical disk, a flexible disk, a CD (Compact Disk), a DVD, or a semiconductor memory.

The program reservation portion 111 (corresponding to part of the program reservation means) accepts manipulations from the user, through the remotecontroller 2, and it sets the start date and hour information and end date and hour information of a program on the basis of the accepted manipulations. Incidentally, the program reservation portion 111 stores the set start date and hour information and end date and hour information in the RAM 12 shown in FIG. 2.

The date and hour decision portion 112 (corresponding to date and hour decision means) decides whether or not a start date and hour set by the program reservation portion 111 has been reached. Concretely, the date and hour decision portion 112 includes a timepiece function, and it compares the start date and hour information stored in the RAM 12 and current time information, thereby to decide whether or not the current time has agreed with the start date and hour stored in the RAM 12 (or whether or not the current time has reached a preset predetermined time period before the start date and hour stored in the RAM 12 (for example, one minute before the start date and hour)).

When it has been decided by the date and hour decision portion 112 that the start date and hour have been reached, the display propriety decision portion 113 (corresponding to display propriety decision means) decides whether or not the digital broadcast receiver 1 is in a displayable state where it can give an output to the display 183 in the manner to be visible from outside. Concretely, the display propriety decision portion 113 decides the displayable state in a case where the power source is in its ON state, and where the digital broadcast receiver 1 is not in its standby state. That is, the display propriety decision portion 113 decides that the digital broadcast receiver 1 is not in its displayable state, in a case where the power source is in its OFF state or where the digital broadcast receiver 1 is in its standby state.

When it has been decided by the display propriety decision portion 113 that the digital broadcast receiver 1 is not in its displayable state, the reserved recording portion 114 (corresponding to reserved recording means) causes the digital broadcast receiver 1 to receive the program set by the program reservation portion 111, through the reception portion 15 shown in FIG. 2, and it causes the DVD recorder 3 to record the received program, through the HDMI interface portion 19. Concretely, when it has been decided by the display propriety decision portion 113 that the digital broadcast receiver 1 is not in its displayable state, the reserved recording portion 114 first decides whether or not the DVD recorder 3 is in its recordable state. In addition, when it has been decided that the DVD recorder 3 is not in its recordable state, the reserved recording portion 114 outputs instruction information for bringing the DVD recorder 3 into its recordable state. Further, when the DVD recorder 3 has fallen into its recordable state, the reserved recording portion 114 causes the DVD recorder 3 to record the received program.

Here, the reserved recording portion 114 decides that the DVD recorder 3 is in its recordable state, in a case where the power source of the DVD recorder 3 is in its ON state and where the DVD recorder 3 is not in its standby state. That is, the reserved recording portion 114 decides that the DVD recorder 3 is not in its recordable state, in a case where the power source of the DVD recorder 3 is in its OFF state or where the DVD recorder 3 is in its standby state. Besides, in the case where the power source of the DVD recorder 3 is in its OFF state, the reserved recording portion 114 outputs instruction information for bringing the power source into its ON state, to the DVD recorder 3 through the HDMI interface portion 19, as instruction information for establishing the recordable state. Further, in the case where the DVD recorder 3 is in its standby state, the reserved recording portion 114 outputs instruction information for resetting the DVD recorder 3 from the standby state (namely, for bringing the power source into its ON state), to the DVD recorder 3 through the HDMI interface portion 19, as instruction information for establishing the recordable state.

When it has been decided by the display propriety decision portion 113 that the digital broadcast receiver 1 is in its displayable state, the switch portion 115 (corresponding to switch means) causes the digital broadcast receiver 1 to receive the program set by the program reservation portion 111, through the reception portion 15 shown in FIG. 2, and it causes the digital broadcast receiver 1 to output the received program to the display 183 shown in FIG. 2.

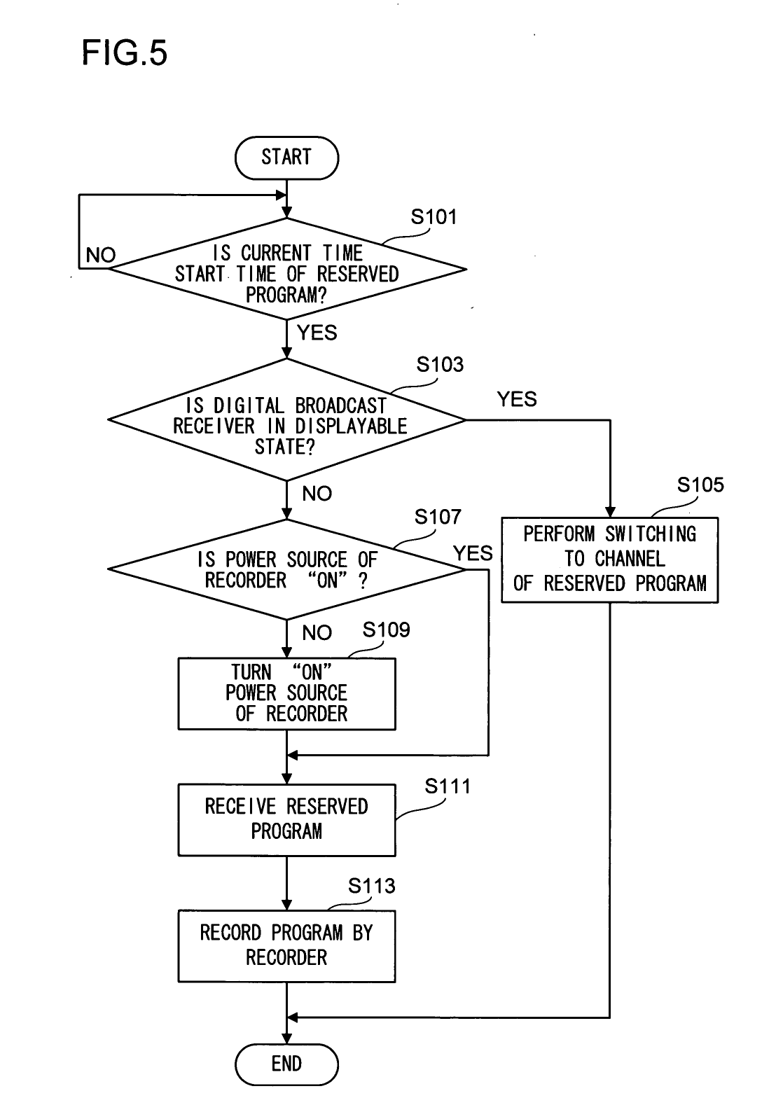

FIG. 5 is a flow chart showing an example of the operation of the digital broadcast receiver 1 (chiefly, the MPU 11). Incidentally, a case where a program has been set (that is, a viewing reservation has been made) by the program reservation portion 111 beforehand will be described here for the sake of convenience. First, whether or not the start date and hour of the program reserved to be viewed has been reached is decided by the date and hour decision portion 112 (S101). Subject to the decision that the start date and hour have not been reached (“NO” at the step S101), a process is held in a wait state. Subject to the decision that the start date and hour have been reached (“YES” at the step S101), whether or not the digital broadcast receiver 1 is in its displayable state is decided by the display propriety decision portion 113 (S103).

Subject to the decision that the digital broadcast receiver 1 is in its displayable state (“YES” at the step S103), the program reserved to be viewed is received by the reception portion 15 through the switch portion 115 (that is, a channel corresponding to the program reserved to be viewed is selected through the tuner portion 152 shown in FIG. 2), and the received program is outputted to the display 183 (S105), whereupon the process is ended.

On the other hand, subject to the decision that the digital broadcast receiver 1 is not in its displayable state (“NO” at the step S103), whether or not the DVD recorder 3 is in its recordable state (namely, in its ON state) is decided by the reserved recording portion 114 (S107). Subject to the decision that the DVD recorder 3 is in its recordable state (namely, in its ON state) (“YES” at the step S107), the process is advanced to a step S111. On the other hand, subject to the decision that the DVD recorder 3 is not in its recordable state (namely, in its ON state) (in other words, that the power source of the DVD recorder 3 is in its OFF state, or that the DVD recorder 3 is in its standby state) (“NO” at the step S107), instruction information for bringing the DVD recorder 3 into the recordable state (namely, into the ON state) is outputted by the reserved recording portion 114, and the DVD recorder 3 is brought into its recordable state (namely, into its ON state) (S109).

In a case where the processing of the step S109 has ended, or in the case where the decided result of the step S107 is “YES”, the program reserved to be viewed is received by the reception portion 15 through the reserved recording portion 114 (S111). In addition, the program received through the reserved recording portion 114 is recorded by the DVD recorder 3 through the HDMI interface portion 19 (S113), whereupon the process is ended.

In this way, the manipulations from the user are accepted through the remotecontroller 2, the start date and hour information and end date and hour information of the program are set on the basis of the accepted manipulations, and whether or not the set start date and hour have been reached is decided. In addition, subject to the decision that the start date and hour have been reached, it is decided whether or not the digital broadcast receiver 1 is in its displayable state being the state where the output can be given to the display 183 in the manner to be visible from outside. Here, when it has been decided that the digital broadcast receiver 1 is not in its displayable state, the set program (namely, the program reserved to be viewed) is received, and the received program is recorded by the DVD recorder 3. Therefore, the program reserved to be viewed can be viewed without fail.

That is, the program reserved to be viewed is recorded by the DVD recorder 3, subject to the decision that the digital broadcast receiver 1 is not in its displayable state. It is therefore permitted to read out the program recorded by the DVD recorder 3 and to output the recorded program to the display 183 in the visible manner. Accordingly, the program reserved to be viewed can be viewed without fail.

Besides, the set program (namely, the program reserved to be viewed) is recorded by the DVD recorder 3 through the HDMI. Therefore, even when the DVD recorder 3 is in the state where its power source is “OFF” (or it is in its standby state), it can be shifted into the state where its power source is “ON” (namely, into its recordable state), through the HDMI, and the DVD recorder 3 can be caused to record the program reserved to be viewed, without fail.

Further, subject to the decision that the digital broadcast receiver 1 is in its displayable state, the set program (namely, the program reserved to be viewed) is received, and the received program is outputted to the display 183. Therefore, the program reserved to be viewed can be viewed with ease.

Incidentally, the invention is also applicable to aspects as stated below:

(A) This embodiment has been described as to the case where the broadcast reception apparatus is the digital broadcast receiver 1, but the broadcast reception apparatus may receive a television broadcast and output the received television broadcast to the display 183 in the manner to be visible from outside. By way of example, the broadcast reception apparatus may well be in an aspect in which it receives an analog broadcast, or in an aspect in which it receives an analog broadcast and a digital broadcast.

(B) This embodiment has been described as to the case where the information record apparatus is the DVD recorder 3, but the information record apparatus may be an apparatus which is so configured that information obtained by receiving a television broadcast can be stored in a record medium. By way of example, it is also allowed to perform an aspect in which the information record apparatus is a video tape recorder or a personal computer including an HDD (Hard Disk Drive).

(C) This embodiment has been described as to the case where the digital broadcast receiver 1 is communicably connected with the DVD recorder 3 through the HDMI, but it is also allowed to perform an aspect in which the constituents 1 and 3 are communicably connected through any other interface. Besides, the connection should preferably be such that the digital broadcast receiver 1 is capable of communicating instruction information for bringing the DVD recorder 3 into. its recordable state, to the DVD recorder 3.

By way of example, it is also allowed to perform an aspect in which the digital broadcast receiver 1 is connected with the DVD recorder 3 through infrared communications so as to be capable of communicating the instruction information for bringing the DVD recorder 3 into its recordable state, to the DVD recorder 3. Besides, it is also allowed to perform an aspect in which the digital broadcast receiver 1, for example, is configured unitarily with the DVD recorder 3 (that is, an aspect in which a “unitary video recorder type television set” is configured).

(D) This embodiment has been described as to the case where the monitor is the display 183 disposed in the digital broadcast receiver 1, but it is also allowed to perform an aspect in which the monitor is configured as a device separate from the digital broadcast receiver 1. By way of example, it is also allowed to perform an aspect in which the monitor is a monitor disposed in a personal computer.

(E) This embodiment has been described as to the case where the program reservation portion 111 accepts manipulations from a user, through the remotecontroller 2, but it is also allowed to perform an aspect in which the program reservation portion 111 accepts the manipulations from the user, through the manipulation portion 14.

### LIST OF RELEVANT REFERENCES

1. JP-A-2000-295538

What is claimed is:

1. A broadcast reception apparatus which receives a television broadcast and outputs the received television broadcast to a monitor in a manner to be visible from outside, and which is communicably connected with an information record apparatus that stores received information therein; comprising:
program reservation means for accepting external manipulations, and for setting start date and hour information and end date and hour information of a program on the basis of the accepted manipulations;
date and hour decision means for deciding whether or not the start date and hour set by said program reservation means have been reached;
display propriety decision means for deciding whether or not the broadcast reception apparatus is in a displayable state being a state where an output is given to a monitor in a manner to be visible from outside, when it has been decided by said date and hour decision means that the start date and hour have been reached; and
reserved recording means for causing the broadcast reception apparatus to receive the program set by said program reservation means, and for causing the information record apparatus to record the received program, when it has been decided by said display propriety decision means that the broadcast reception apparatus is not in the displayable state.

2. A broadcast reception apparatus according to claim 1, wherein the broadcast reception apparatus is connected to the information record apparatus in a manner to be capable of communicating instruction information which brings the information record apparatus into a recordable state.

3. A broadcast reception apparatus according to claim 2, wherein:
the broadcast reception apparatus is connected with the information record apparatus communicably through an HDMI (High Definition Multimedia Interface); and
said reserved recording means causes the information record apparatus to record the program set by said program reservation means, through said HDMI.

4. A broadcast reception apparatus according to claim 2, wherein:
the broadcast reception apparatus is connected with the information record apparatus communicably through infrared communications; and
said reserved recording means causes the information record apparatus to record the program set by said program reservation means, through the infrared communications.

5. A broadcast reception apparatus according to claim 2, wherein the broadcast reception apparatus is configured unitarily with the information record apparatus.

6. A broadcast reception apparatus according to claim 1, comprising switch means for causing the broadcast reception apparatus to receive the program set by said program reservation means and to output the received program to the monitor, when it has been decided by said display propriety decision means that the broadcast reception apparatus is in the displayable state.

7. A broadcast reception apparatus according to claim 2, comprising switch means for causing the broadcast reception apparatus to receive the program set by said program reservation means and to output the received program to the monitor, when it has been decided by said display propriety decision means that the broadcast reception apparatus is in the displayable state.

8. A broadcast reception apparatus according to claim 3, comprising switch means for causing the broadcast reception apparatus to receive the program set by said program reservation means and to output the received program to the monitor, when it has been decided by said display propriety decision means that the broadcast reception apparatus is in the displayable state.

9. A broadcast reception apparatus according to claim 4, comprising switch means for causing the broadcast reception apparatus to receive the program set by said program reservation means and to output the received program to the monitor, when it has been decided by said display propriety decision means that the broadcast reception apparatus is in the displayable state.

10. A broadcast reception apparatus according to claim 5, comprising switch means for causing the broadcast reception apparatus to receive the program set by said program reservation means and to output the received program to the monitor, when it has been decided by said display propriety decision means that the broadcast reception apparatus is in the displayable state.

11. A digital broadcast receiver which receives a television broadcast and outputs the received television broadcast to a monitor in a manner to be visible from outside, and which is connected with a DVD recorder for storing received information therein, communicably through an HDMI (High Definition Multimedia Interface), comprising:
program reservation means for accepting external manipulations through a remotecontroller, and for setting start date and hour information and end date and hour information of a program on the basis of the accepted manipulations;
date and hour decision means for deciding whether or not the start date and hour set by said program reservation means have been reached;
display propriety decision means for deciding whether or not the digital broadcast receiver is in a displayable state being a state where an output is given to a monitor in a manner to be visible from outside, when it has been decided by said date and hour decision means that the start date and hour have been reached;
reserved recording means for causing the digital broadcast receiver to receive the program set by said program reservation means, and for causing the DVD recorder to record the received program through the HDMI, when it has been decided by said display propriety decision means that the digital broadcast receiver is not in the displayable state; and
switch means for causing the digital broadcast receiver to receive the program set by said program reservation means and to output the received program to the monitor, when it has been decided by said display propriety decision means that the digital broadcast receiver is in the displayable state.
